(19) United States
(12) Patent Application Publication
(10) Pub. No.: US 2026/0077219 A1
(43) Pub. Date: Mar. 19, 2026

(54) HIGH RISE FIREFIGHTING METHOD AND ARRANGEMENT

(71) Applicant: Thomas JONKERS, Singapore (SG)

(72) Inventor: Thomas JONKERS, Singapore (SG)

(21) Appl. No.: 19/111,037

(22) PCT Filed: Sep. 13, 2023
(86) PCT No.: PCT/NL2023/050473

§ 371 Date: Mar. 12, 2025

Related U.S. Application Data
(60) Provisional application No. 63/406,391, filed on Sep. 14, 2022.

(51) Int. Cl. A62C 3/00; A62C 27/00; A62C 31/28

(52) U.S. Cl. CPC A62C 3/00; A62C 27/00; A62C 31/28

(57) ABSTRACT

Disclosed is a method for firefighting a fire (120) in a high-rise building (50), comprising: providing at least three anchor points (40, 45, 47) each having an anchor location; providing a mount plate (60) arranged for mounting firefighting equipment on the mounting plate; arranging wires (70, 75, 80) between the respective anchor points and the mount plate; and providing winches (15, 20, 25), wherein each winch is arranged for winching the respective wire for changing the length of wire between the anchor point and the mount plate; wherein the at least three anchor locations define an anchor triangle; and wherein the at least three anchor locations are positioned such that a distance from the anchor triangle to at least part of the fire is at most 75 metres, preferably less than 50 metres, more preferably 25 metres, most preferably 10 metres.

### FIELD OF THE INVENTION

The invention relates to a method for firefighting a fire in a high-rise building. The invention further relates to a support arrangement. The invention further relates to a data processing system. The invention further relates to a data processing system and computer-readable storage medium.

### BACKGROUND OF THE INVENTION

Firefighting high-rise buildings may be difficult due to the fact that ladders may not be able to reach the fire from the outside, allowing firefighting only from the inside.

Fires in buildings are fought or put out by firefighters. One essential element for fighting fires in buildings is that firefighters need to reach the fire with their equipment typically from the inside as well as from the outside of the building. As an example, a firehose carrying water under pressure may be used to extinguish a fire several metres or even more than ten metres away from the outside of the building. To extend the reach of a firehose, a ladder may be used to reach a fire higher in the building from the outside. Still, high-rise buildings are typically of such height that the fire cannot be reached with a firehose on a ladder from the outside.

CN102886107(A) discloses a firefighting and lifesaving device for a high-rise building, and discloses a building firefighting set, which belongs to a building firefighting set device. The firefighting and lifesaving device for the high-rise building comprises a control system and a firefighting and lifesaving device, wherein the firefighting and lifesaving device is arranged at any position on the top of the high-rise building; at least a wireless signal receiver-transmitter and a remote control end arranged on the firefighting and lifesaving device are arranged in the control system; an elevating device is arranged on a firefighting and lifesaving frame, and is connected with a rotary firefighting and lifesaving arm through an arm support; the firefighting and lifesaving arm is provided with a sliding overhead travelling crane; and the arm support mechanism can also be placed on a walking mechanism, and movement on the top of a special-shaped high-rise building through a track is realized. A disadvantage of this device is that the device is rather big. Furthermore, the device needs to be in place on top of the high-rise building before the fire breaks out. Typically, the device is placed on top of the building during construction. A further disadvantage is that the device is suspended from one wire which may cause instability of the device arranged at the end of the wire.

### SUMMARY OF THE INVENTION

An object of the invention is to overcome one or more of the disadvantages mentioned above.

According to a first aspect of the invention, a method for firefighting a fire in a high-rise building, comprising: providing at least three anchor points each having an anchor location; providing a mount plate arranged for mounting firefighting equipment on the mounting plate; arranging wires between the respective anchor points and the mount plate; and providing winches, wherein each winch is arranged for winching the respective wire for changing the length of wire between the anchor point and the mount plate; wherein the at least three anchor locations define an anchor triangle; and wherein the at least three anchor locations are positioned such that a distance from the anchor triangle to at least part of the fire is at most 75 metres, preferably less than 50 metres, more preferably 25 metres, most preferably 10 metres.

The method comprises providing at least three anchor points, providing a mount plate, arranging wires, and providing winches.

The step of providing at least three anchor points may comprise shooting, drilling, anchoring and/or placing at least one of the anchor points in a building, such as the high-rise building having the fire, alternatively a high-rise building next to the high-rise building having the fire.

Each anchor point has an anchor location. The location may be a 3D coordinate. The 3D coordinate may be relative to a reference axis and an origin. The origin and the axis may be relative to the building position and orientation. The origin and the axis may be relative to a firefighting vehicle position and orientation, typically providing one of the anchor points.

The mount plate is arranged for receiving, mounting, attaching and/or integrating firefighting equipment for fighting the fire. The mount plate may also be arranged for other purposes, such as coupling to a stretcher or basket for rescuing people form the building, or bringing firefighting equipment up, and in or out of the building on fire.

The wires should be long enough for running from the winches via the respective anchor point to the mount plate. The length of the wire may be different depending on where the winches are arranged. For example, if the winch is arranged on the ground, while the associated anchor point is arranged above the fire, the length of the wire, associated with the winch and the anchor point, may be over 100 metres, such as over 200 metres, or even 300 metres or more in length, for running from the winch up to the anchor point and then down to the ground again for coupling with the mount plate. In an alternative embodiment, one or more of the winches may be integrated on the mount plate. In an alternative embodiment, a winch and an anchor point may be integrated. Combinations of these embodiments are also possible.

The winches are arranged for winching the wires for changing the length of wire between the anchor point and the mount plate. The location of the mount plate can be changed and/or controlled by changing the length of the wire between the anchor point and the mount plate. Each wire is associated with one winch and one anchor point. Each wire is at one end attached to the mount plate and on the other end associated with or wound up on one winch.

The at least three anchor locations define the anchor triangle. The at least three anchor locations are selected such that the distance from the anchor triangle to at least part of the fire is at most 75 metres, preferably less than 50 metres, more preferably 25 metres, most preferably 10 metres. The technical effect of the selection of the at least three anchor locations positioned in a triangle at a particular distance is that the mount plate is positionable such that the firefighting equipment mounted on the mount plate can reach the fire from the outside of the building easily. Furthermore, the anchor points are relatively light compared to other solutions allowing for quick deployment of the method during a fire. Furthermore, at least one, preferably at least two anchor points can be placed in advance of the fire e.g., during construction of the building preferably on top of the building. Furthermore, the mount plate is more stable allowing use of a high-pressure water hose and/or use in high wind conditions and/or allowing use of the method at relative long distances from the fire advantageously minimizing the exposure of the firefighting material on the mount plate to the fire.

According to another aspect of the invention, a support arrangement for firefighting a fire in a high-rise building, comprising: at least three anchor points arrangeable for anchoring; a mount plate arranged for mounting firefighting equipment for fighting the fire; wires arrangeable between the respective anchor points and the mount plate; and winches arrangeable for winching a respective wire of the wires for changing the wire length between the respective anchor point and the mount plate; wherein the at least three anchor points in use each have an anchor location; wherein the at least three anchor locations define an anchor triangle; and wherein the at least three anchor locations are positioned such that a distance from the anchor triangle to at least part of the fire is at most 75 metres, preferably less than 50 metres, more preferably 25 metres, most preferably 10 metres. This aspect of the invention provides the same advantageous as mentioned for the other aspects of the invention. The support arrangement may be combined with features mentioned for other aspects of the invention, such as for the method for firefighting, for providing the same advantages.

According to another aspect of the invention, a method for data processing system comprising means for carrying out the steps of the mentioned controller. This aspect of the invention provides the same advantages as mentioned for the other aspects of the invention. This aspect of the method for data processing may be combined with features mentioned for other aspects of the invention, such as for the method for firefighting, for providing the same advantages. The method for data processing may be combined with features mentioned for other aspects of the invention, such as for the method for firefighting, for providing the same advantages.

According to another aspect of the invention, a computer-readable storage medium comprising instructions which, when executed by a computer, cause the computer to carry out the steps of any of the mentioned embodiments or claims for the method for controlling energy harvesting. This aspect of the invention provides the same advantageous as mentioned for the other aspects of the invention. The computer-readable storage medium may be combined with features mentioned for other aspects of the invention, such as for the method for firefighting, for providing the same advantages.

### DETAILED DESCRIPTION OF EXEMPLARY EMBODIMENTS

In an embodiment of the method for firefighting, the at least three anchor locations define an anchor plane; and the anchor plane deviates from the vertical less than 40 degrees, preferably 30 degrees, more preferably 20 degrees, most preferably 10 degrees. The anchor plane deviating a maximum number of degrees from the vertical during use advantageously allows to reach the fire high on the high-rise building with not too much wire. Furthermore, the anchor plane deviating a maximum number of degrees from the vertical during use advantageously allows that the mount plate positioned somewhere in the angle triangle does not leave the angle triangle too much while limiting the tension on the wires.

In an embodiment of the method for firefighting, the at least three anchor locations define an anchor plane; and the anchor plane deviates from the vertical at least 2 degrees, preferably 5 degrees, more preferably 8 degrees, most preferably 15 degrees. The anchor plane deviating a minimum number of degrees from the vertical during use allows to position the anchor point or points below the fire not directly under the fire, thereby advantageously positioning the anchor point or points, and typically also the associated winch or winches, outside the area of falling debris coming from the fire and thus the danger zone.

In an embodiment of the method for firefighting, providing at least three anchor points comprises selecting the at least three anchor locations such that two anchor locations are above and on either side of the at least part of the fire. Arranging at least two anchor locations above and on either side of the at least part of the fire allows the mount plate to be advantageously positioned over a large area high on the high rise-building. Directly above the fire is typically hot and difficult to reach due to the smoke coming and/or rising from the fire. Arranging at least two anchor locations above and on either side of the at least part of the fire advantageously allows to minimize the exposure of material and/or firefighters working setting up an anchor point to the heat and/or smoke from the fire.

In an embodiment of the method for firefighting, providing at least three anchor points comprises selecting the at least three anchor locations such that one anchor location is below the at least part of the fire, preferably on the ground. Having an anchor point on the ground provides the advantage of being easily and/or quickly arranged during arrival at the scene of the fire by the firefighters. Arranging the anchor point on the ground may advantageously comprise integrating the anchor point in a firefighting vehicle.

In an embodiment of the method for firefighting, the distance is a horizontal distance, or the distance is an angled distance having a maximum upward angle relative to the horizontal of 60 degrees, more preferably 45 degrees, more preferably 35 degrees, most preferably 30 degrees. The mount plate when comprising firefighting equipment, such as a firehose, expelling water and/or a foam towards the at least part of the fire is limited in the upward angle to advantageously maximize the reach of the expelled water and/or foam.

In an embodiment of the method for firefighting, the method comprises winching the wires such that the mount plate is moveable substantially in the anchor triangle. Especially when the anchor plane is deviating from the vertical, the mount plate may be moveable close to the anchor triangle. The more the tension on the wires is increased the more the mount plate is moving close to the anchor triangle. The anchor triangle defines an easily identifiable position space for the mount plate. The operator may advantageously easily position the mount plate within the anchor triangle due to this easily identifiable position space.

In an embodiment of the method for firefighting, the method comprises winching the wires with slack. In particular situations, the mount plate is to be positioned outside the anchor triangle, such as when delivering equipment to the building. Providing slack to at least one wire, preferably more of the wires, allows to position the mount plate not only substantially inside the anchor triangle. The slack especially in combination with an angle plane deviating from the vertical allows positioning the mount plate inside a positioning volume. The positioning volume is bordered by the anchor triangle on one side and the ground plane. The positioning volume is further bordered, in case of two higher anchor points and one low anchor point, by a vertical plane through the two higher anchor points, and two vertical planes respectively between either of the two higher anchor points and the lowest anchor point. The positioning volume is further bordered, in case of two equally low anchor points and one higher anchor point, two vertical planes respectively between either of the two lower anchor points and the higher anchor point. Winching with slack advantageously allows to position the mount plate within this positioning volume. Notice should be taken that slack in one of the wires such as the lower wire in combination with water, foam or other expelled from the mount plate towards the fire may cause instability of the mount plate.

In a further embodiment of the method for firefighting, when winching the wire with slack and the anchor plane deviates from the vertical, the mount plate is moveable outside the anchor plane with the use of gravity acting on the mount plate. This embodiment further details, winching with slack advantageously allows to position the mount plate within this positioning volume.

In an embodiment of the method for firefighting, providing winches is providing at least one, preferably two, more preferably all, winches on the ground; and arranging wires comprises arranging the wires between the respective winch to the mount plate via the respective anchor point. Providing the winch or winches on the ground allows to easily move the winch or winches. In a further embodiment, the winch or the winches are installed and/or integrated on a fire truck, allowing the winch or winches to advantageously be easily brought together with other fire equipment to the fire.

In an embodiment of the support arrangement for firefighting, the mount plate comprises a coupling for coupling to a firehose for advantageously depositing a fire extinguishing liquid, such as water or foam, on the at least part of the fire.

In an embodiment of the support arrangement for firefighting, the mount plate comprises a camera for providing a view on the at least part of the fire. In another embodiment, the mount plate may advantageously comprise an anemometer, bullhorn, infrared detector or camera, a pump, such as a water pump, and/or a winch, which may be one of the at least three winches or may be a separate winch for winching or hoisting equipment to and from the mount plate. Combinations of these embodiments are possible.

In an embodiment of the support arrangement for firefighting, the mount plate comprises a/the coupling for coupling to a stretcher for rescuing people in a high-rise building and/or carrying up firefighting equipment. This advantageously allows the method and support arrangement to be applied in a multi-purpose role.

In an embodiment of the support arrangement for firefighting, one of the winches is integrated with a firefighting vehicle; and the firefighting vehicle is the associated anchor point. This advantageously makes the associated anchor point easily moveable towards the scene of the fire. Furthermore, the weight of the firefighting vehicle advantageously provides a stable platform for the anchor point.

In a further embodiment of the support arrangement for firefighting, all winches are integrated with the firefighting vehicle; and only one anchor point is associated with the firefighting vehicle. This advantageously makes the winches easily moveable towards the scene of the fire and already provides one anchor point. Furthermore, the weight of the firefighting vehicle advantageously provides a stable platform for at least one anchor point as well as winches having their wires running from the firefighting vehicle to the respective anchor points and then to the mount plate.

In an embodiment of the support arrangement for firefighting, the support arrangement comprises a controller arranged for controlling at least two winches, preferably three winches, more preferably all winches. The controller may be a controller for providing a constant tension to the wires. The controller may be distributed over multiple winches wherein each winch comprises a sub-controller controlling the wire tension of that winch. The sub-controller may communicate the wire tension to a central sub-controller and/or sub-controllers of other winches. The controller advantageously allows an operator to control the winches and thus the support arrangement.

In a further embodiment of the support arrangement for firefighting, the controller is arranged for: receiving a location of the at least three anchor points; receiving lengths of wire between the respective anchor points and the mount plate; and controlling the winches for moving the mount plate. Receiving lengths of wire may comprise receiving the number of turns from each winch, such as the number of turns of a drum of each winch, for estimating the length of wire released or issued from the winch. This embodiment advantageously provides a way of controlling the mount plate.

In a further embodiment of the support arrangement for firefighting, the controller is arranged for: receiving a direction, and a distance and/or a speed for changing the position of the mount plate; calculating the length of the wire between the respective anchor points and the mount plate; and activating the respective winches for changing the length of wire between the respective anchor points and the mount plate to the respective calculated lengths. This embodiment advantageously provides a way of controlling the mount plate.

In a further embodiment of the support arrangement for firefighting, the controller is arranged for: receiving an input for activating one of the winches; and activating one of the winches based on the input. This embodiment may have that the other winches are set to maintain a particular wire tension thereby providing automatic adaptation of the wire length thereby typically distributing the controller, as mentioned before, and/or an advantageously simplified control by an operator of the support arrangement.

In an embodiment of the support arrangement for firefighting, the support arrangement comprises at least one sensor for measuring a tension on one of the wires, preferably the wire arranged between the lowest anchor point and the mount plate; wherein the controller is arranged for: retrieving a tension setting for the one of the wires; receiving the tension in the one of the wires; and controlling the winch associated with the one of the wires for adapting the tension to the tension setting. This embodiment is typically with a distributed controller comprising sub-controllers each associated with or comprised by a winch. The tension setting may be a tension range wherein the tension of the wire is maintained by the controller. This embodiment may have that the other winch or winches are manipulated to change the length of wire or the lengths of wires for advantageously simplifying the control of the overall control of the support arrangement by an operator as this winch is operating relatively autonomous. Further, the tension of the wire may advantageously be kept such that the wire tension is always below a safe working load or working load limit, typically below a minimum breaking load, which is a tension possibly damaging or even breaking the wire. In a further embodiment, these steps are integrated in a sub-controller integrated with the winch for advantageously providing a constant tension winch.

### BRIEF DESCRIPTION OF THE DRAWINGS

The invention will be apparent from and elucidated further with reference to the embodiments described by way of example in the following description and with reference to the accompanying drawings, in which:

FIG. 1 schematically shows a deployed support arrangement for firefighting ready for use;

FIG. 2 schematically shows a deployed support arrangement while firefighting;

FIG. 3 schematically shows a deployed support arrangement while firefighting;

FIG. 4 schematically shows a deployed support arrangement for firefighting picking up a load;

FIG. 5 schematically shows a deployed support arrangement for firefighting with a suspended load;

FIG. 6 schematically shows a deployed support arrangement while firefighting; and

FIG. 7 schematically shows an embodiment of a computer program product, computer readable medium and/or non-transitory computer readable storage medium according to the invention.

The figures are purely diagrammatic and not drawn to scale. In the figures, elements which correspond to elements already described may have the same reference numerals.

LIST OF REFERENCE NUMERALS

| | |
|---|---|
| 10 | vehicle with winches |
| 15 | winch centre |
| 20 | winch left |
| 25 | winch right |
| 40 | anchor point left |
| 45 | anchor point right |
| 47 | anchor point low |
| 48 | anchor triangle |
| 49 | distance |
| 50 | high rise building |
| 60 | multi-purpose mount plate |
| 70 | left hoist wire |
| 75 | right hoist wire |
| 80 | centre wire |
| 90 | firehose |
| 100 | fire floor |
| 110 | pump vehicle |
| 120 | fire |
| 130 | hook |
| 135 | load |
| 200 | support arrangement |
| 1000 | computer program product |
| 1010 | computer readable medium |
| 1020 | computer readable code |

### DETAILED DESCRIPTION OF THE FIGURES

The following figures may detail different embodiments. Embodiments can be combined to reach an enhanced or improved technical effect. These combined embodiments may be mentioned explicitly throughout the text, may be hint upon in the text or may be implicit.

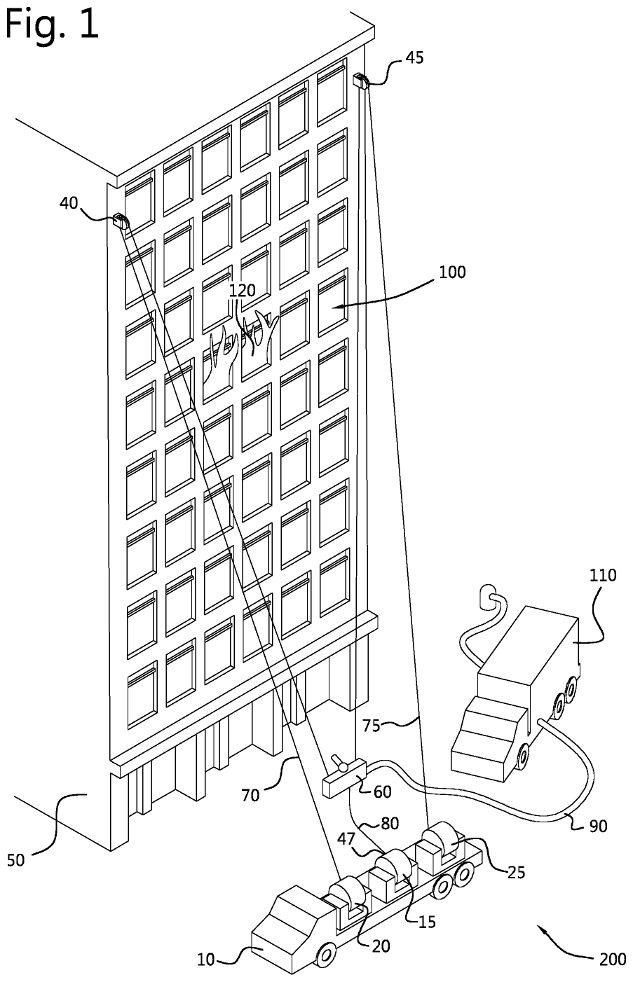

FIG. 1 schematically shows a deployed support arrangement 200 for firefighting ready for use. The support arrangement for firefighting a fire 120 in a high-rise building 50 comprises at least three anchor points 40, 45, 47, a mount plate 60, wires 70, 75, 80, and winches 15, 20, 25.

FIG. 1 further shows a perspective view of a high rise building 50 that includes a vehicle with winches 10, elevated anchor points 40, 45, mount plate 60 and a firehose 90.

From the vehicle with winches 10 the left hoist wire 70 may be guided via a not shown guide point to the left side of the high rise building 50 and from there the wire goes to elevated anchor point 40. A similar arrangement is made on the right side where the right hoist wire 75 goes to elevated anchor point 45 via an optional guide point. Both hoist wires are then guided down by/via elevated anchor points 40 and 45 and are mechanically attached to the mount plate 60. From the vehicle with winches 10 another wire, the centre wire 80, runs directly to the mount plate 60.

The left hoist wire 70 may be spooled on the left winch 20 with a constant tension, and the right hoist wire 75 may be spooled on the right winch 25 with a constant tension. The centre wire 80 may be spooled on the centre winch 15 with a constant tension.

Typically, the winches are placed onto a vehicle 10 with all winches 15, 20, 25. Alternatively, due to space constraints, one or more of the winches may be placed next to the vehicle, on other vehicles and/or on the building on fire or on neighbouring buildings. One or more of the winches may also be placed “stand alone”.

The winches 20, 25 have a sufficient length of wire spooled on them to reach the vehicle 10 with winches via the optional guide points and elevated anchor points 40, 45, plus some spare length. The optional guide points may be points where a sheave, pulley or snatch block is secured to a vehicle or to a fixed or moveable structure (dumb weight) capable of holding the force that is exerted on the guide point by the hoist wires 70, 75.

The hoist wires 70, 75 are typically certified steel wires or cables with a safe working load sufficient for the designed operations.

The sheaves, pulleys, or snatch blocks, that guide hoist wires 70, 75, are mechanically attached to the elevated anchor points 40, 45. From the elevated anchor points 40, 45, the hoist wire 70, 75 are guided to and mechanically attached to the mount plate 60. The centre wire 80, coming from the centre winch 15, may directly be connected to the mount plate 60. The result of this arrangement is that mount plate 60 is mechanically secured by the two hoist wires and the one centre wire.

Pressured water may be supplied to a fire hose 90 by a pump vehicle 110. For explanatory purposes a fire 120 is ongoing on a fire floor 100

The mount plate 60 is a versatile mechanical construction that functions as a holding/mounting plate for various appliances, apparatus and/or equipment, such as a fire monitor, a fire hose, a fire pump, a camera, an anemometer, and/or a suspended load.

Emergency fire services may first tension up the system by increasing the pull force in all wires attached to the mount plate 60. The winches, which may be controlled by software, may maintain a pre-set tension between the wires.

By varying the force in each wire, the mount plate 60 can be moved in upward, downward and to a left and right direction. As the other winches may be maintained at a constant wire tension, the mount plate may be positioned in the anchor triangle.

Furthermore, an angled plane of the system, named an anchor plane, relative to high rise building 50, will also allow for movement of the mount plate 60 towards and from the building.

When increasing the forces in hoist wires 70, 75 and at the same time decreasing the force in the centre wire 80, the mount plate 60 will move upwards towards fire floor 100.

Software may allow an operator of the system to carefully bring the mount plate 60 to the desired height and/or the desired position. It is envisaged that controlling the mount plate 60 will be done by means of a joystick.

Once the mount plate 60 has reached the desired height and/or the desired position the services, such as the emergency services, can start fighting the fire. When emergency services are finished the mount plate 60 can be brought back to ground level by means of the same control, such as a joystick control.

The system can be used in different ways or applications. One way is to use the system to fight fire whilst it also can be used to hoist materials and equipment to and from the high-rise building.

FIG. 1 further shows a fire hose 90 coming from pump vehicle 110 is connected to the mount plate 60 which is still at ground level. When the system is ready the operator may move the mount plate 60 near or close to the fire 120 and this will allow the emergency services to spray water, foam or other on the fire.

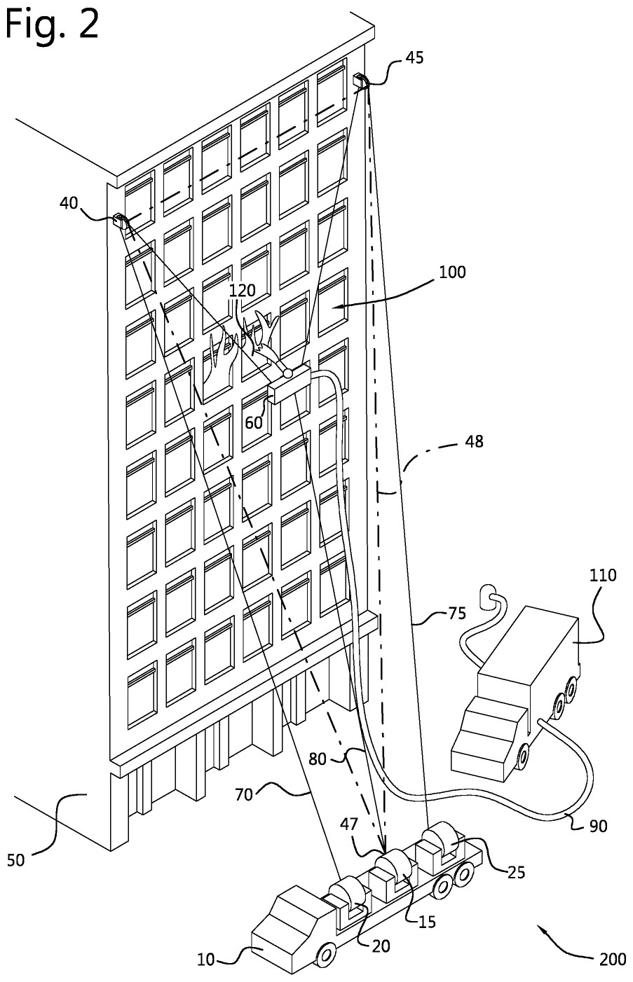

FIG. 2 schematically shows a deployed support arrangement while firefighting. The support arrangement is similar or even equal to the support arrangement of FIG. 1. FIG. 2 further shows the anchor triangle 48. The anchor triangle is the triangular area between the anchor points. The anchor triangle may be substantially the movement area wherein the mount plate may be moved and/or positioned.

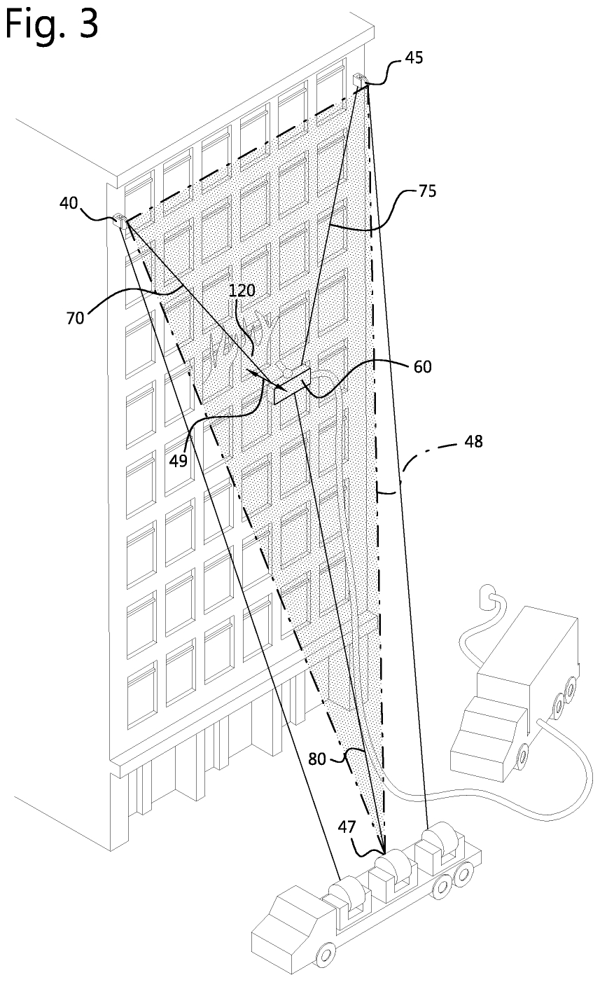

FIG. 3 schematically shows a deployed support arrangement while firefighting. FIG. 3 further shows that the mount plate 60 has reached the fire 120. Apart from supplying water additional functionality can be added to/mounted onto the mount plate 60, e.g. monitoring equipment, signalling equipment, winching equipment and storage of equipment.

FIG. 3 further shows the anchor triangle 48. The anchor triangle is the triangular area between the anchor points. The anchor triangle may be substantially the movement area wherein the mount plate may be moved and/or positioned. The Figure further shows the distance 49 between the anchor triangle and at least part of the fire.

In this case the distance is shown as the horizontal distance between the anchor triangle and at least part of the fire. In another case the distance may alternatively be defined as the shortest distance between the anchor triangle and at least part of the fire. In this particular case, the mount plate is positioned across of at least part of the fire, such that the distance also indicates the distance between the mount plate substantially positioned inside the anchor triangle and at least part of the fire.

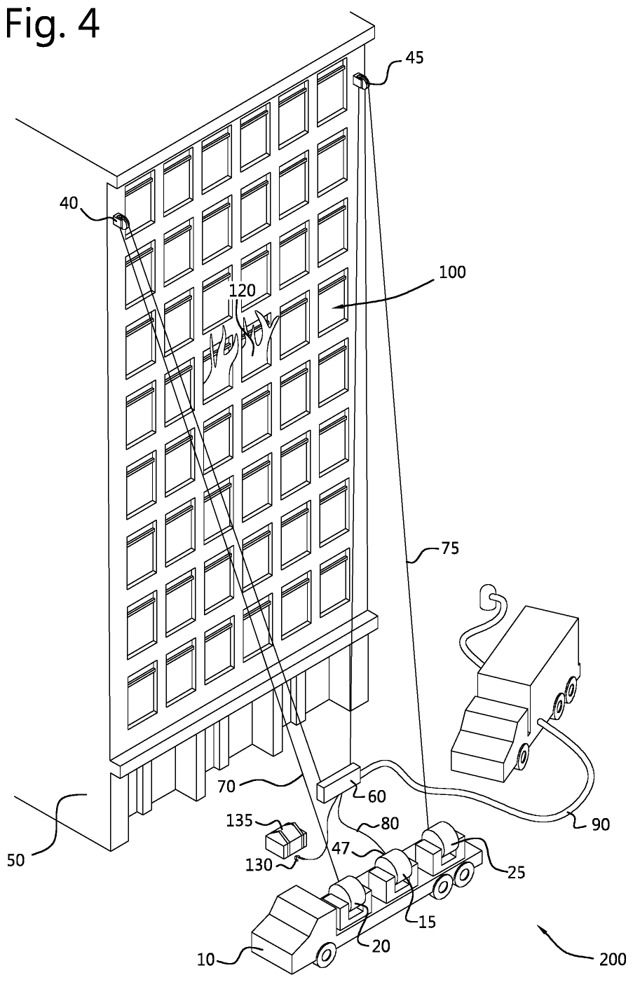

FIG. 4 schematically shows a deployed support arrangement for firefighting picking up a load 135. FIG. 4 further shows the mount plate comprising a hook 130. The hook may be used to pick up load, such as materials and/or equipment, simply by using the hook to lift the load 135 up. The load is typically mechanically integrated with the mount plate 60 and is ready to be hoisted after deploying the system.

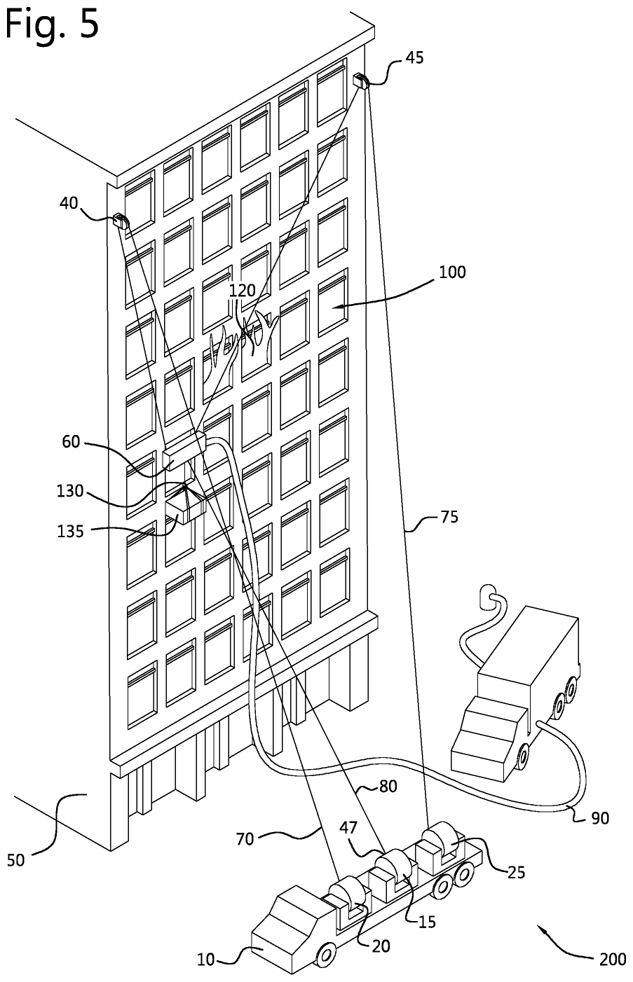

FIG. 5 schematically shows a deployed support arrangement for firefighting with a suspended load e.g firefighting equipment. The load is shown hoisted to desired floor level. By reducing a pulling force on the centre line 80 of the mount plate 60 with the hook 130 with a load will move towards the high rise building 50 and the load can be offloaded by emergency fire services located inside the building. Alternatively, system method may be used for transport of people to and from high rise building.

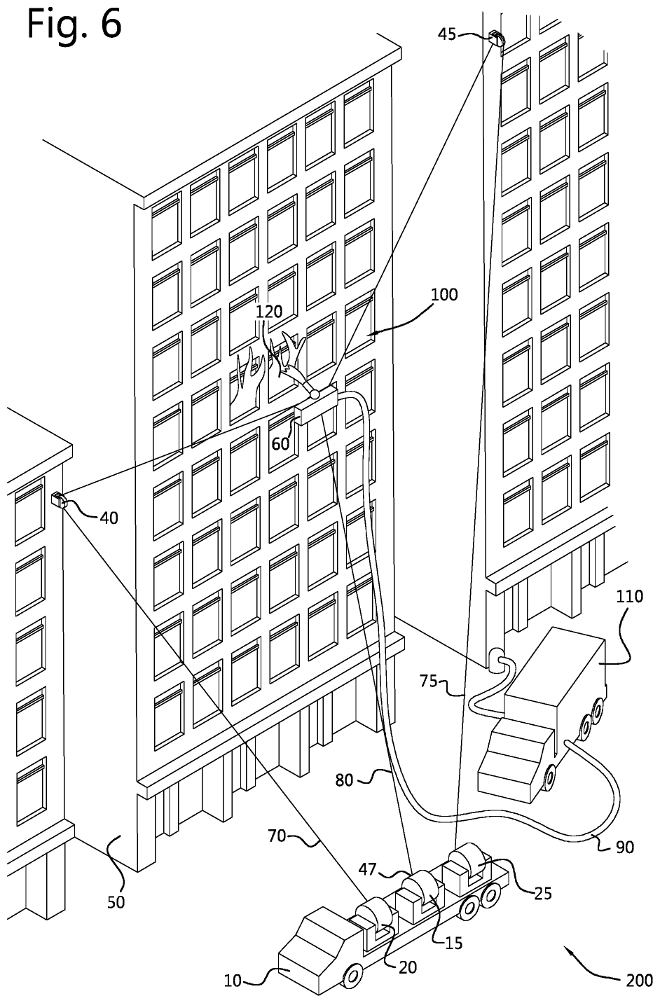

FIG. 6 schematically shows a deployed support arrangement for firefighting while firefighting. The elevated anchor points are advantageously arranged, positioned, or placed on other buildings. As the elevated anchor points are arranged to other buildings, these anchor points are less exposed to heat and other negative effects of the fire. As the elevated anchor points are arranged to other buildings, the firefighter or firefighters may advance above the height of the fire for installing the anchor point without the risk of being trapped in the building on fire and above the fire. This embodiment also advantageously shows three winches installed or integrated on one firefighting vehicle 10.

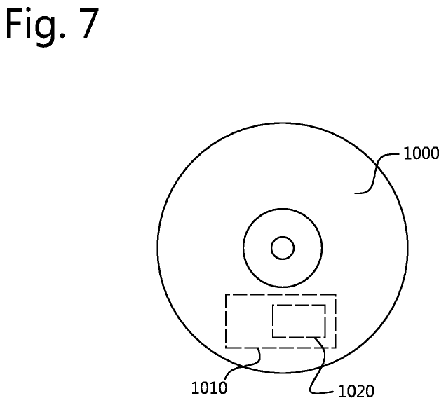

FIG. 7 schematically shows an embodiment of a computer program product 1000, computer readable medium 1010 and/or non-transitory computer readable storage medium according to the invention comprising computer readable code 1020.

It will also be clear that the above description and drawings are included to illustrate some embodiments of the invention, and not to limit the scope of protection. These embodiments are within the scope of protection and the essence of this invention and are obvious combinations of prior art techniques and the disclosure of this patent. Devices functionally forming separate devices may be integrated in a single physical device.

The term “substantially” herein, such as in “substantially all emission” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” also includes embodiments wherein the term “comprises” means “consists of”.

The term “functionally” will be understood by, and be clear to, a person skilled in the art. The term “substantially” as well as “functionally” may also include embodiments with “entirely”, “completely”, “all”, etc. Hence, in embodiments the adjective functionally may also be removed. When used, for instance in “functionally parallel”, a skilled person will understand that the adjective “functionally” includes the term substantially as explained above. Functionally in particular is to be understood to include a configuration of features that allows these features to function as if the adjective “functionally” was not present. The term “functionally” is intended to cover variations in the feature to which it refers, and which variations are such that in the functional use of the feature, possibly in combination with other features it relates to in the invention, that combination of features is able to operate or function. For instance, if an antenna is functionally coupled or functionally connected to a communication device, received electromagnetic signals that are receives by the antenna can be used by the communication device. The word “functionally” as for instance used in “functionally parallel” is used to cover exactly parallel, but also the embodiments that are covered by the word “substantially” explained above. For instance, “functionally parallel” relates to embodiments that in operation function as if the parts are for instance parallel. This covers embodiments for which it is clear to a skilled person that it operates within its intended field of use as if it were parallel.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. Thus, these terms are not necessarily intended to indicate temporal or other prioritization of such elements.

The devices or apparatus herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and “to include”, and its conjugations does not exclude the presence of elements or steps other than those stated in a claim. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The article “a” or “an” preceding an element does not exclude the presence of a plurality of such elements.

The invention may be implemented by means of hardware comprising several distinct elements, and by means of a suitably programmed computer. In the device or apparatus claims enumerating several means, several of these means may be embodied by one and the same item of hardware.

The invention further applies to an apparatus or device comprising one or more of the characterising features described in the description and/or shown in the attached drawings. The invention further pertains to a method or process comprising one or more of the characterising features described in the description and/or shown in the attached drawings.

It will be appreciated that the invention also applies to computer programs, particularly computer programs on or in a carrier, adapted to put the invention into practice. The program may be in the form of a source code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing stage of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical wire or by radio or other means. When the program is embodied in such a signal, the carrier may be constituted by such a wire or other device or means. Alternatively, the carrier may be an integrated circuit in which the program is embedded, the integrated circuit being adapted to perform, or used in the performance of, the relevant method.

The various aspects discussed in this patent can be combined in order to provide additional advantages.

1. A method for firefighting a fire in a high-rise building, comprising:
providing at least three anchor points each having an anchor location;
providing a mount plate arranged for mounting firefighting equipment on the mount plate;
arranging wires between the respective anchor points and the mount plate; and
providing winches, wherein each winch is arranged for winching the respective wire for changing the length of wire between the anchor point and the mount plate;
wherein the at least three anchor locations define an anchor triangle; and
wherein the at least three anchor locations are positioned such that a distance from the anchor triangle to at least part of the fire is at most 75 metres, preferably less than 50 metres, more preferably 25 metres, most preferably 10 metres.

2. The method of claim 1,
wherein the at least three anchor locations define an anchor plane; and
wherein the anchor plane deviates from the vertical less than 40 degrees, preferably 30 degrees, more preferably 20 degrees, most preferably 10 degrees.

3. The method of claim 1, wherein providing at least three anchor points comprises selecting the at least three anchor locations such that two anchor locations are above and on either side of the at least part of the fire.

4. The method of claim 1, wherein providing at least three anchor points comprises selecting the at least three anchor locations such that one anchor location is below the at least part of the fire, preferably on the ground.

5. The method of claim 1, wherein the distance is a horizontal distance, or the distance is an angled distance having a maximum upward angle relative to the horizontal of 60 degrees, more preferably 45 degrees, more preferably 35 degrees, most preferably 30 degrees.

6. The method of claim 1, further comprising one of
winching the wires such that the mount plate is moveable substantially in the anchor triangle, and
winching the wires with slack.

7. (canceled)

8. The method of claim 2 further comprising winching the wires with slack, wherein when winching the wire with slack and the anchor plane deviates from the vertical, the mount plate is moveable outside the anchor plane with the use of gravity acting on the mount plate.

9. The method of claim 1,
wherein providing winches is providing one of one, two, more than two, and all winches on the ground; and
wherein arranging wires comprises arranging the wires between the respective winch to the mount plate via the respective anchor point.

10. A support arrangement for firefighting a fire in a high-rise building, comprising:
at least three anchor points arrangeable for anchoring;
a mount plate arranged for mounting firefighting equipment for fighting the fire;
wires arrangeable between the respective anchor points and the mount plate; and
winches arrangeable for winching a respective wire of the wires for changing the wire length between the respective anchor point and the mount plate;
wherein the at least three anchor points in use each have an anchor location;
wherein the at least three anchor locations define an anchor triangle; and
wherein the at least three anchor locations are positioned such that a distance from the anchor triangle to at least part of the fire is at most 75 metres, preferably less than 50 metres, more preferably 25 metres, most preferably 10 metres.

11. The support arrangement of claim 10, wherein the mount plate comprises a coupling for coupling to a firehose for depositing a fire extinguishing liquid on the at least part of the fire.

12. The support arrangement of claim 10, wherein the mount plate comprises a camera for providing a view on the at least part of the fire.

13. The support arrangement of claim 10, wherein the mount plate comprises a/the coupling for coupling to a stretcher for rescuing people in a high-rise building and/or carrying up firefighting equipment.

14. The support arrangement of claim 10,
wherein one of the winches is integrated with a firefighting vehicle; and
wherein the firefighting vehicle is the associated anchor point.

15. The support arrangement of claim 10,
wherein one of
all winches are integrated with the firefighting vehicle; and
only one anchor point is associated with the firefighting vehicle.

16. The support arrangement of claim 10 further comprising a controller arranged for controlling one of two winches, three winches, more than three winches, and all winches.

17. The support arrangement of claim 16, wherein the controller is arranged for:
receiving a location of the at least three anchor points;
receiving lengths of wire between the respective anchor points and the mount plate; and
controlling the winches for moving the mount plate.

18. The support arrangement of claim 16, wherein the controller is arranged for:
receiving a direction, and a distance and/or a speed for changing the position of the mount plate;
calculating the length of the wire between the respective anchor points and the mount plate; and
activating the respective winches for changing the length of wire between the respective anchor points and the mount plate to the respective calculated lengths.

19. The support arrangement of claim 16, wherein the controller is arranged for:
receiving an input for activating one of the winches; and
activating one of the winches based on the input.

20. The support arrangement of claim 16 further comprising at least one sensor for measuring a tension on one of the wires, preferably the wire arranged between the lowest anchor point and the mount plate;
wherein the controller is arranged for:
retrieving a tension setting for the one of the wires;
receiving the tension on the one of the wires; and
controlling the winch associated with the one of the wires for adapting the tension to the tension setting.

21. (canceled)

22. A computer-readable storage medium comprising instructions which, when executed by a computer, cause the computer to carry out the steps of the controller of claim 16.
